(19) United States
(12) Patent Application Publication
(10) Pub. No.: US 2010/0187940 A1
(43) Pub. Date: Jul. 29, 2010

(54) Rotating electrical machine

(75) Inventors: Yoshihisa Yamamoto, Anjo-shi (JP); Ken Takeda, Anjo-shi (JP); Tomohiro Inagaki, Anjo-shi (JP); Yasuo Yamaguchi, Anjo-shi (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/656,183

(22) Filed: Jan. 20, 2010

(30) Foreign Application Priority Data
Jan. 23, 2009 (JP) 2009-013309

(51) Int. Cl. H02K 3/12; H02K 1/02

(52) U.S. Cl. 310/201; 310/216.067

(57) ABSTRACT

A rotating electrical machine that includes a stator formed by winding a coil around a stator core of a substantially cylindrical shape; and a rotor rotatably supported at an inside in a radial direction of the stator, wherein at least one coil end portion in an axial direction of the stator is a curved coil end portion formed to be curved inward in a radial direction of the stator core.

### INCORPORATION BY REFERENCE

The disclosure of Japanese Patent Application No. 2009-013309 filed on Jan. 23, 2009, including the specification, drawings and abstract is incorporated herein by reference in its entirety.

### BACKGROUND

The present invention relates to a rotating electrical machine including a stator formed by winding a coil around a stator core of a substantially cylindrical shape and a rotor rotatably supported at an inside in a radial direction of the stator.

As a technology related to a rotating electrical machine including a stator formed by winding a coil around a stator core of a substantially cylindrical shape and a rotor rotatably supported at an inside in a radial direction of the stator, there is disclosed a structure of a rotating electrical machine as described below, for example, in Japanese Patent Publication No. 3928297 (pages 5 to 7, FIG. 1) shown below. That is, this rotating electrical machine has a structure in which at least one of both coil end portions of a coil that are located at both outer sides in the axial direction of a stator core is curved inward in a radial direction thereof so that a tip of the coil end comes close to a rotor. With the structure of the rotating electrical machine described above, since the curved coil end portion that is curved inward in a radial direction faces close to an axial end surface of the rotor, a magnetic flux generated in the curved coil end portion can be supplied to the rotor, thereby enabling increase torque and efficiency of the rotating electrical machine.

### SUMMARY

However, in the structure disclosed in Japanese Patent Publication No. 3928297, the rotor is structured such that permanent magnets are inserted into a rotor core structured by laminating a plurality of silicon steel plates in the axial direction thereof, and is only structured such that the axial end surface of the rotor core faces the curved coil end portion. With such a structure, the silicon steel plates composing the rotor core are arranged in a plane orthogonal to the magnetic flux from the curved coil end portion. Therefore, an eddy current is likely to flow in the silicon steel plates, and thus there has been a problem that eddy current loss is likely to increase.

In addition, the structure disclosed in Japanese Patent Publication No. 3928297 is not provided with a structure for actively generating a torque to rotate the rotor, on the axial end surface of the rotor that faces the curved coil end portion, by receiving the magnetic flux from the curved coil end portion. In addition, the direction in which the permanent magnets of the rotor are magnetized and the shape of the rotor core are not configured so as to generate the torque to rotate the rotor efficiently with respect to a direction of the magnetic flux from the curved coil end portion. Consequently, since the magnetic field from the curved coil end portion is not used efficiently, the degrees of increase in torque and energy efficiency have been very small.

In order to solve the problems, it is an object of the present invention to suppress eddy current loss caused by a magnetic field generated by a curved coil end portion in a rotating electrical machine in which at least one coil end portion in the axial direction of a stator is the curved coil end portion formed to be curved inward in a radial direction of a stator core. In addition, if such a rotating electrical machine is provided with a torque generating portion using the magnetic field generated by the curved coil end portion, it is another object of the present invention to increase torque in the rotating direction of the rotor by using the magnetic field efficiently.

In order to achieve the objects, a rotating electrical machine according to an aspect of the present invention including a stator formed by winding a coil around a stator core of a substantially cylindrical shape and a rotor rotatably supported at an inside in a radial direction of the stator has a characteristic structure, in which at least one coil end portion in an axial direction of the stator is a curved coil end portion formed to be curved inward in a radial direction of the stator core, the rotor includes a rotor core of a substantially cylindrical shape and an opposed end plate mounted concentrically with the rotor core on an axial end surface of the rotor core so as to face the curved coil end portion, the opposed end plate is mainly composed of compacted powder material formed by pressing magnetic powder particles which are powder particles of magnetic material, and the magnetic powder particles composing the compacted powder material are in a non-conductive state between each other, in which a current induced by the magnetic field generated by the curved coil end portion is restricted.

Here, the coil end portion is a portion of the coil projected from the end portion in the axial direction of the stator core, on each of the one and the other sides in the axial direction of the stator. In addition, in the present application, the term “rotating electrical machine” is used as a concept that includes any of a motor (electric motor), a generator (electrical generator), and a motor-generator that serves as a motor or a generator depending on the necessity.

In the rotating electrical machine structured as mentioned above, the portion of the rotor that faces the curved coil end portion is most strongly influenced by the magnetic field generated by the curved coil end portion. With this characteristic structure, the portion of the rotor mentioned above is arranged with the opposed end plate that is mainly composed of the compacted powder material formed by pressing the magnetic powder particles and whose magnetic powder particles composing the compacted powder material are in the non-conductive state between each other. Therefore, the current induced by the magnetic field generated by the curved coil end portion can be effectively suppressed from flowing through the rotor. Consequently, the eddy current loss caused by the magnetic field generated by the curved coil end portion can be significantly reduced, compared with the structure in which the rotor core directly faces the curved coil end portion as disclosed in Japanese Patent Publication No. 3928297, or with the structure provided with an end plate composed of material with a high electrical conductivity, such as aluminum. Therefore, the energy efficiency of the rotating electrical machine can be increased.

Here, it is preferable that the opposed end plate has a torque generating portion that generates a torque in a rotating direction of the rotor by using the magnetic field generated by the curved coil end portion, on a surface that faces the curved coil end portion.

With this structure, the torque generating portion is provided in the portion of the opposed end plate that faces the curved coil end portion and is most strongly influenced by the magnetic field generated by the curved coil end portion. Therefore, the torque in the rotating direction of the rotor can be increased by efficiently using the magnetic field generated by the curved coil end portion. Consequently, it is also possible to increase torque of the rotating electrical machine while reducing the eddy current loss by suppressing the current induced by the magnetic field generated by the curved coil end portion from flowing through the rotor.

In addition, it is preferable that the compacted powder material is formed by pressing magnetic powder particles having a higher magnetic permeability than that of the air, and the torque generating portion is structured by having a plurality of salient pole portions formed to project in directions approaching the curved coil end portion, along the circumferential direction of the opposed end plate.

With this structure, the opposed end plate has a magnetic saliency, due to the salient pole portions formed to project in directions approaching the curved coil end portion. Therefore, the opposed end plate can generate a reluctance torque acting in the rotating direction of the rotor due to the rotating magnetic field generated by the curved coil end portion. Consequently, it is also possible to increase torque of the rotating electrical machine while reducing the eddy current loss by suppressing the current induced by the magnetic field generated by the curved coil end portion from flowing through the rotor.

In addition, it is preferable that the torque generating portion is structured by having a plurality of permanent magnets arranged between the salient pole portions adjoining each other in the circumferential direction of the opposed end plate, and the plurality of permanent magnets are arranged so as to have polarities that are alternately reversed relative to the curved coil end portion along the circumferential direction of the opposed end plate.

With this structure, a magnet torque acting in the rotating direction of the rotor can also be generated in addition to the reluctance torque by the salient pole portions, as the plurality of permanent magnets attract or repel the rotating magnetic field generated by the curved coil end portion. Consequently, it is possible to further increase torque of the rotating electrical machine while reducing the eddy current loss by suppressing the current induced by the magnetic field generated by the curved coil end portion from flowing through the rotor.

In addition, it is also preferable that the torque generating portion is structured by having a plurality of permanent magnets arranged so as to have polarities that are alternately reversed relative to the curved coil end portion along the circumferential direction of the opposed end plate, in a structure in which the salient pole portions are not provided along the circumferential direction of the opposed end plate, or in the state in which the salient pole portions are provided but the plurality of permanent magnets are arranged at places other than the places between the salient pole portions.

With this structure, the magnet torque acting in the rotating direction of the rotor can be generated as the plurality of permanent magnets attract or repel the rotating magnetic field generated by the curved coil end portion. Consequently, it is possible to increase torque of the rotating electrical machine while reducing the eddy current loss by suppressing the current induced by the magnetic field generated by the curved coil end portion from flowing through the rotor.

In addition, it is also preferable that the compacted powder material is formed by pressing magnetic powder particles of hard magnetic material capable of becoming permanent magnets, and the torque generating portion is structured by having permanent magnets produced by magnetizing a part or all of the compacted powder material composing the opposed end plate so as to have polarities that are alternately reversed relative to the curved coil end portion along the circumferential direction of the opposed end plate.

With this structure, the magnet torque acting in the rotating direction of the rotor can be generated as the plurality of permanent magnets attract or repel the rotating magnetic field generated by the curved coil end portion. Consequently, it is possible to increase torque of the rotating electrical machine while reducing the eddy current loss by suppressing the current induced by the magnetic field generated by the curved coil end portion from flowing through the rotor. In addition, with this structure, the permanent magnets composing the torque generating portion can be provided integrally with the opposed end plate.

In addition, it is preferable that the stator core has a plurality of slots provided at predetermined intervals along the circumferential direction thereof, the curved coil end portion includes radial conductor portions that extend out from the slots and extend in radial directions of the stator and circumferential conductor portions that extend in the circumferential direction so as to connect between the plurality of radial conductor portions extending out from different slots, and the torque generating portion is provided in an area that faces the radial conductor portions with respect to a radial direction of the opposed end plate.

With this structure, the torque generating portion can generate the torque in the rotating direction of the rotor, by efficiently using the magnetic field that is strengthened in the area surrounded by the plurality of radial conductor portions extending out from the different slots and the circumferential conductor portions connecting therebetween. Consequently, it is possible to efficiently increase torque of the rotating electrical machine while reducing the eddy current loss by suppressing the current induced by the magnetic field generated by the curved coil end portion from flowing through the rotor.

In addition, it is preferable that the compacted powder material is formed by pressing magnetic powder particles each of which is formed with an electrically insulating film on the surface thereof.

With this structure, the magnetic powder particles composing the compacted powder material can appropriately be in the non-conductive state between each other. Consequently, the current induced by the magnetic field generated by the curved coil end portion can be effectively suppressed from flowing through the opposed end plate mainly composed of the compacted powder material.

In addition, it is preferable that the compacted powder material is formed by pressing magnetic powder particles using electrically insulating material as binder, while using the magnetic powder particles formed with the electrically insulating films on the surfaces thereof or using the magnetic powder particles not formed with such electrically insulating films.

With this structure, the magnetic powder particles composing the compacted powder material can appropriately be in the non-conductive state between each other. Consequently, the current induced by the magnetic field generated by the curved coil end portion can be effectively suppressed from flowing through the opposed end plate mainly composed of the compacted powder material.

In addition, it is preferable that the opposed end plate is formed into a substantially circular disc shape covering the entire axial end surface of the rotor core.

With this structure, a substantially entire area of the axial end surface of the rotor core that faces the curved coil end portion can be covered by the opposed end plate of a substantially circular disc shape. Therefore, a magnetic flux by the magnetic field generated by the curved coil end portion can be suppressed from reaching the axial end surface of the rotor core that faces the curved coil end portion. Consequently, it is possible to effectively suppress the current induced by the magnetic field generated by the curved coil end portion from flowing through the rotor.

In addition, it is preferable that a coil end core is arranged by being inserted into gaps between conductors composing the curved coil end portion.

With this structure, the density of the magnetic flux directing toward the opposed end plate can be increased in the case in which the surface of the opposed end plate that faces the curved coil end portion is provided with the torque generating portion that generates the torque in the rotating direction of the rotor by using the magnetic field generated by the curved coil end portion. Consequently, it is possible to further increase torque of the rotating electrical machine.

In addition, it is preferable that the coil end core is mainly composed of compacted powder material formed by pressing magnetic powder particles which are powder particles of magnetic material, and the magnetic powder particles composing the compacted powder material are in a non-conductive state between each other, in which a current induced by the magnetic field generated by the curved coil end portion is restricted.

With this structure, the current induced by the magnetic field generated by the curved coil end portion can be restricted from flowing through the coil end core. Therefore, it is possible to suppress eddy current loss from being generated in the coil end core. Consequently, the energy efficiency of the rotating electrical machine can be increased by suppressing the eddy current loss while increasing the density of the magnetic flux directing toward the opposed end plate. In addition, with this structure, it is possible to form a core of a complicated shape compared with the case of forming the coil end core by laminating magnetic steel sheets. Therefore, the coil end core can be formed into an appropriate shape in accordance with the shape of the gaps between the conductors composing the curved coil end portion, even if the shape of the gaps is complicated.

### BRIEF DESCRIPTION OF THE DRAWINGS

FIG. 1 is a perspective view showing an overall view of a rotating electrical machine according to a first embodiment of the present invention;

FIG. 2 is an axial sectional view of the rotating electrical machine according to the first embodiment of the present invention;

FIG. 3 is a perspective view of an opposed end plate according to the first embodiment of the present invention;

FIG. 4 is a perspective view showing an overall view of a rotating electrical machine according to a second embodiment of the present invention;

FIG. 5 is a perspective view of an opposed end plate according to the second embodiment of the present invention;

FIG. 6 is a perspective view of an opposed end plate according to a third embodiment of the present invention;

FIG. 7 is a perspective view showing an overall view of a rotating electrical machine according to a fourth embodiment of the present invention;

FIG. 8 is an axial sectional view of the rotating electrical machine according to the fourth embodiment of the present invention; and

FIG. 9 is a perspective view of a coil end core according to the fourth embodiment of the present invention.

### DETAILED DESCRIPTION OF EMBODIMENTS

### 1. First Embodiment

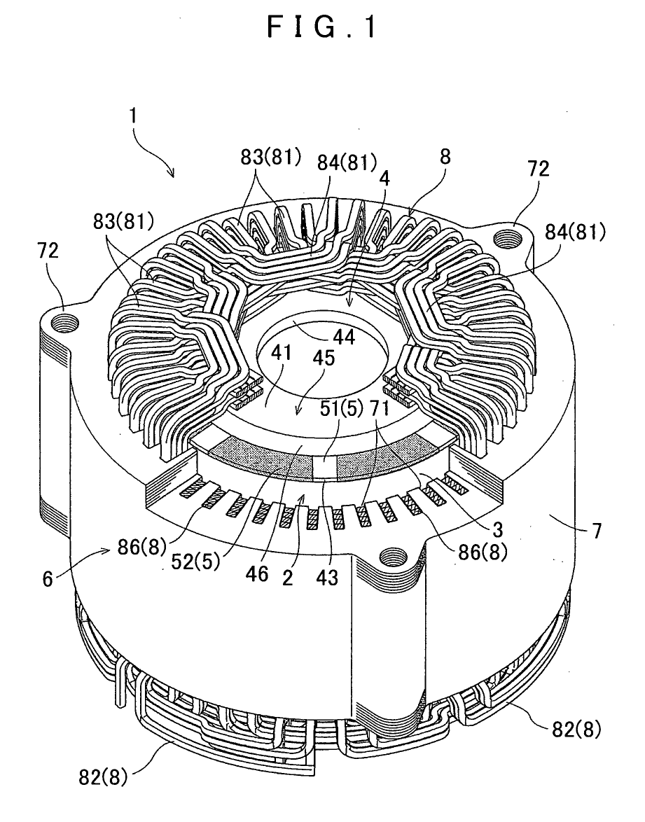

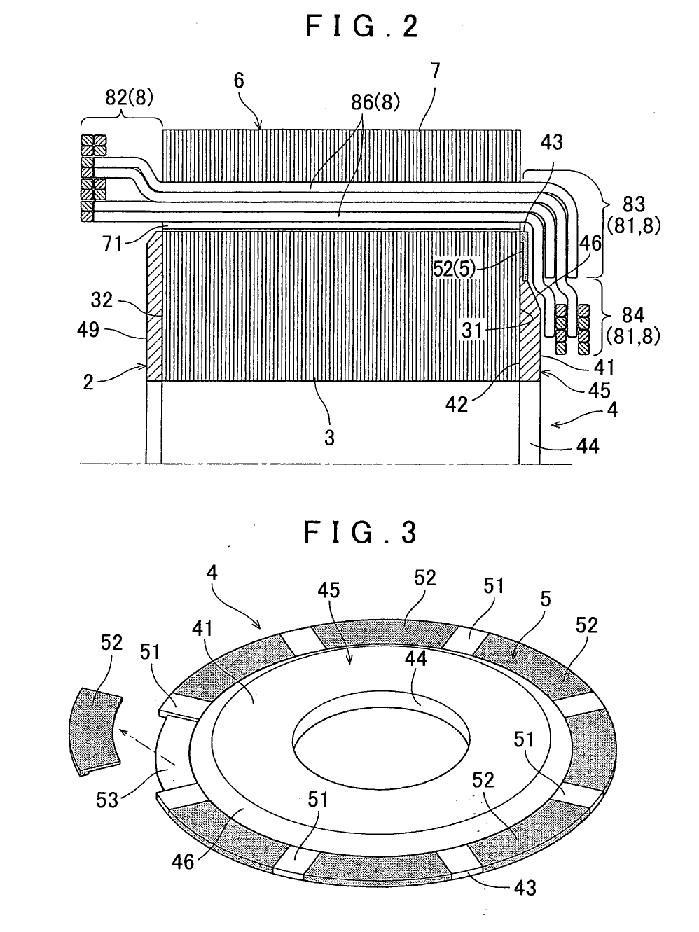

A first embodiment of the present invention will be described based on the drawings. As shown in FIGS. 1 and 2, a rotating electrical machine 1 according to the present embodiment is provided with a stator 6 formed by winding a coil 8 around a stator core 7 of a substantially cylindrical shape, and a rotor 2 rotatably supported at an inside in a radial direction of the stator 6. In the present embodiment, only one of two coil end portions 81 and 82 provided on both sides in the axial direction of the stator 6 is a curved coil end portion 81 formed to be curved inward in a radial direction of the stator core 7. In addition, the rotor 2 is provided with a rotor core 3 of a substantially cylindrical shape, and an opposed end plate 4 that is mounted concentrically with the rotor core 3 on an axial end surface 31 of the rotor core 3 so as to face the curved coil end portion 81. The rotating electrical machine 1 according to the present invention is particularly characterized in the structure of the opposed end plate 4. The structure of the rotating electrical machine 1 according to the present embodiment will be described in detail below with reference to FIGS. 1 to 3.

### 1-1. Structure of Stator

As shown in FIGS. 1 and 2, the stator 6 is structured by having the stator core 7 of a substantially cylindrical shape and the coil 8 wound around the stator core 7. The stator core 7 is structured by laminating a plurality of magnetic steel sheets, and here, formed into a substantially cylindrical shape by laminating the plurality of magnetic steel sheets of a substantially circular ring shape. In addition, the stator core 7 has a plurality of slots 71 provided at predetermined intervals along the circumferential direction. Here, the plurality of slots 71 extending in the axial direction of the stator 6 are provided at the predetermined intervals along the circumferential direction on the inner circumferential surface of the stator core 7. The slots 71 have the same cross-sectional shape as each other, with predetermined width and depth. The present embodiment is structured such that a three-phase alternating current of U-phase, V-phase, and W-phase is fed to and drawn from the coil 8. The number of poles is “8” and the number of slots per pole per phase is “2” in the stator 6. Accordingly, the slots are arranged on the inner circumferential surface of the stator 6 so that two slots for each of the three phases of U-phase, V-phase, and W-phase are arranged in a sequentially repeated manner, thereby providing 48 of the slots 71 on the entire circumference. The stator 6 is provided, at three places in the circumferential direction on the outer circumferential surface thereof, with mounting portions 72 for fixing the stator 6 to a case, which is not shown, or the like. Each of the mounting portions 72 is formed so that the outer circumferential surface of the stator core 7 partially protrudes, and structured by having, in the central part thereof, a circular hole penetrating in the axial direction. The stator 6 is fixed to the case or the like by inserting fastening members such as bolts through the circular holes.

The coil 8 is wound in the slots 71 provided on the stator core 7. In the present embodiment, the coil 8 is structured by combining linear conductors that are formed in advance into a predetermined shape in which the conductors can be wound around the stator 7. A plurality of such linear conductors are inserted into each of the slots 71 of the stator core 7. In the example shown in the figures, four of the linear conductors are inserted in each of the slots 71. In addition, the linear conductors composing the coil 8 have a rectangular cross section. Here, the coil 8 is composed of coils of U-phase, V-phase, and W-phase, and four linear conductors of the same phase are inserted in each of two adjoining slots.

The coil 8 is composed of the linear conductors, and has a plurality of coil side portions 86 that are composed of portions inserted in the slots 71 of the stator core 7, and the coil end portions 81 and 82 that are composed of portions continuous with the coil side portions 86 and extending out in the axial direction of the stator 6 to project in the axial direction from the stator core 7. In the coil side portion 86, the four linear conductors are aligned in a radial direction inside the slot 71. The coil end portions 81 and 82 are structured as parts of the coil 8 projected from end portions in the axial direction of the stator core 7 on one side and the other side, respectively, in the axial direction of the stator 6. In the present embodiment, one of the two coil end portions in the axial direction of the stator 6 is the curved coil end portion 81 formed to be curved inward in a radial direction of the stator core 7. The other coil end portion in the axial direction of the stator 6 is not curved inward in a radial direction of the stator core 7, and is a plain coil end portion 82 arranged on an extension in the axial direction of the stator core 7. This plain coil end portion 82 is structured by having circumferential conductor portions that extend in the circumferential direction in a manner connecting between the plurality of coil side portions 86 arranged in the different slots 71.

The curved coil end portion 81 is structured by having radial conductor portions 83 that extend out from the slots 71 and extend in radial directions of the stator 6 and circumferential conductor portions 84 that extend in the circumferential direction in a manner connecting between the plurality of radial conductor portions 83 extending out from the different slots 71. In the present embodiment, the four linear conductors composing the radial conductor portion 83 are formed so as to be curved inward in a radial direction after extending out from the coil side portion 86 in the axial direction of the stator 6. Consequently, in the radial conductor portion 83, the four linear conductors are aligned such that they are curved inward in a radial direction from the state of being substantially parallel in the axial direction to the state of being substantially parallel in the radial direction, while maintaining the aligned state. Therefore, the radial conductor portion 83 is extended out to further inside in a radial direction than the inner circumferential surface of the stator core 7. In addition, as is obvious from FIGS. 1 and 2, the radial conductor portions 83 are arranged without overlapping each other in the circumferential direction. In the present embodiment, among the linear conductors composing the curved coil end portion 81, the portion of the linear conductors located in the same circumferential position as that of the coil side portion 86 is the radial conductor portion 83.

The linear conductors composing the circumferential conductor portion 84 are formed so as to be extended out from the radial conductor portion 83 corresponding to one of the slots 71 while being curved to the circumferential direction toward the radial conductor portion 83 corresponding to the other of the slots 71, and then curved outward in a radial direction to be connected to the radial conductor portion 83 corresponding to the other of the slots 71. In this case, in the circumferential conductor portion 84, two of the linear conductors located radially outside in the slot 71 are arranged radially side by side, and combined with two of the linear conductors located radially outside in the adjoining slot 71 of the same phase so that four linear conductors in total are arranged radially side by side. In addition, in a position closer to the stator core 7 in the axial direction than those four linear conductors, two of the linear conductors located radially inside in the slot 71 are arranged radially side by side, and combined with two of the linear conductors located radially inside in the adjoining slot 71 of the same phase so that four linear conductors in total are arranged radially side by side. Therefore, the circumferential conductor portion 84 is arranged more inside in a radial direction than the inner circumferential surface of the stator core 7.

### 1-2. Structure of Rotor

As shown in FIGS. 1 and 2, the rotor 2 is provided with the rotor core 3 of a substantially cylindrical shape and end plates 4 and 49 mounted on axial both end surfaces 31 and 32 of the rotor core 3. In addition, although omitted from the drawings, the rotor 2 is provided with a rotor shaft fixed so as to rotate integrally with the rotor core 3, and the rotor shaft is rotatably supported on the case, which is not shown. Therefore, the rotor 2 is supported inside in a radial direction of the stator 6, in a rotatable manner relative to the stator 6. The rotor core 3 is structured by laminating a plurality of magnetic steel sheets, and here, formed into a substantially cylindrical shape by laminating the plurality of magnetic steel sheets of a substantially circular ring shape. In addition, although omitted from drawings, the rotor core 3 is formed with magnet insertion portions at a plurality of places at even intervals in the circumferential direction, and permanent magnets are inserted and fixed in the magnet insertion portions. In the present embodiment, the permanent magnets are arranged along the circumferential direction of the rotor core 3 at eight places which are equivalent in number to the poles of the stator 6. Note that there may be cases in which a plurality of such permanent magnets are arranged at one place. These permanent magnets are arranged so as to be exposed on the surface of the rotor core 3, or to be buried inside. Each of the permanent magnets is magnetized in a radial direction of the rotor 2, and the permanent magnets are arranged at the plurality of places so as to have polarities that are alternately reversed relative to the stator 6 along the circumferential direction of the rotor 2. That is, the polarities of the permanent magnets at the plurality of places are set so that a north pole and a south pole alternate along the circumferential direction of the rotor 2, when viewed from the outside in a radial direction of the rotor 2.

The end plates 4 and 49 are mounted on both axial end surfaces 31 and 32, respectively, of the rotor core 3 mentioned above. These end plates 4 and 49 hold the permanent magnets inserted in the magnet insertion portions of the rotor core 3 integrally with the rotor core 3, and also serve as retainers for fixing the rotor core 3 to the rotor shaft, which is not shown. In the present embodiment, the end plates 4 and 49 are formed to be members of a substantially circular disc shape that are mounted concentrically with the rotor core 3 at the end surfaces 31 and 32 on one side and the other side, respectively, in the axial direction of the rotor 2. In addition, among these two end plates, the end plate provided on one axial end surface 31 of the rotor core 3 facing the curved coil end portion 81 is the opposed end plate 4. The end plate provided on the other axial end surface 32 of the rotor core 3 is the plain end plate 49. Here, the plain end plate 49 is formed into a substantially circular disc shape covering the entire area of the other axial end surface 32 of the rotor core 3. In the present embodiment, the plain end plate 49 is formed of aluminum from the viewpoint of weight and cost reduction. Note that it is also preferable if the plain end plate 49 is formed of compacted powder material formed by pressing magnetic powder particles in the same way as that for the opposed end plate 4 to be described below.

### 1-3. Structure of Opposed End Plate

Next, the structure of the opposed end plate 4 will be described in detail. As mentioned above, because the curved coil end portion 81 of the stator 6 is formed by forming the coil end portion projected from the end portion in the axial direction of the stator core 7 to be curved inward in a radial direction of the stator core 7, a part of the linear conductors composing the curved coil end portion 81 is located in a position facing the axial end surface of the rotor 2. Therefore, in order to suppress eddy current loss in the rotor 2 caused by a magnetic field generated by the curved coil end portion 81 and to increase torque in the rotating direction of the rotor 2 by using the magnetic field efficiently, the rotor 2 is provided with the opposed end plate 4 that is mounted concentrically with the rotor core 3 on the one axial end surface 31 of the rotor core 3 so as to face the curved coil end portion 81. Here, the opposed end plate 4 is formed into a substantially circular disc shape covering the entire area of the axial one end surface 31 of the rotor core 3. Note that the central portion of the opposed end plate 4 in a radial direction is provided with a circular hole in which the rotor shaft, which is not shown, is inserted, and the circumference of this circular hole serves as an inner circumferential surface 44 of the opposed end plate 4. This inner circumferential surface 44 of the opposed end plate 4 is formed so as to be positioned in the same plane as, and continuously with, the inner circumferential surface of the rotor core 3.

The opposed end plate 4 is mainly composed of the compacted powder material formed by pressing the magnetic powder particles which are powder particles of magnetic material. In the present embodiment, the opposed end plate 4 is structured by mounting permanent magnets 52 composing a torque generating portion 5 to be described later on a plate body 45. This plate body 45 is composed of the compacted powder material. Here, the magnetic powder particles composing the compacted powder material are in a non-conductive state between each other so that a current induced by the magnetic field generated by the curved coil end portion 81 is restricted. In the present embodiment, the compacted powder material is formed by pressing the magnetic powder particles each of which is formed with an electrically insulating film on the surface thereof, so that the magnetic powder particles composing the compacted powder material are in the non-conductive state between each other. Here, the magnetic powder particles are powder particles of soft magnetic material, for which, for example, powder particles of iron, iron-silicon based alloy, iron-nitrogen based alloy, iron-nickel based alloy, iron-carbon based alloy, iron-boron based alloy, iron-cobalt based alloy, iron-phosphorus based alloy, iron-nickel-cobalt based alloy, or iron-aluminum-silicon based alloy are preferably used. In addition, as the electrically insulating film, for example, iron phosphate containing phosphorous and iron, or other material such as manganese phosphate, zinc phosphate, calcium phosphate, silicon oxide, titanium oxide, aluminum oxide, or zirconium oxide is preferably used. The insulating film serves as an insulating layer between the magnetic powder particles composing the compacted powder material. Therefore, the electrical resistance of the compacted powder material formed by pressing the magnetic powder particles can be made large. Consequently, the electrical resistance of the opposed end plate 4 (plate body 45) can be made large. As a method of producing the compacted powder material by press-forming the magnetic powder particles, the present embodiment uses a method in which the magnetic powder particles are pressed in a mold to be formed into a predetermined shape and then sintered by heating.

By constituting the plate body 45 of the opposed end plate 4 using the compacted powder material mentioned above, it is possible to cover, with the plate-shaped member of a high electrical resistance, the end portion in the axial direction of the rotor 2 that faces the curved coil end portion 81 and is most strongly influenced by the magnetic field generated by the curved coil end portion 81. Consequently, it is possible to effectively suppress the current induced by the magnetic field generated by the curved coil end portion from flowing through the rotor 2, thereby enabling to suppress the generation of eddy current loss.

In addition, the opposed end plate 4 has, on the surface thereof facing the curved coil end portion 81, the torque generating portion 5 that generates the torque in the rotating direction of the rotor 2 by using the magnetic field generated by the curved coil end portion 81. As shown in FIG. 3, in the present embodiment, the opposed end plate 4 has a plurality of salient pole portions 51 and the plurality of permanent magnets 52 along the circumferential direction, as the torque generating portion 5.

The salient pole portions 51 are structured by portions on the plate body 45 composing the opposed end plate 4 that are formed to project in directions approaching the curved coil end portion 81. Here, because a front face 41 and an outer circumferential surface 43 of the opposed end plate 4 face the curved coil end portion 81, the salient pole portions 51 are formed on both the front face 41 and the outer circumferential surface 43 of the opposed end plate 4 so as to project in directions approaching the curved coil end portion 81. In the present embodiment, the salient pole portions 51 are arranged separately from each other at even intervals along the circumferential direction of the opposed end plate 4 at eight places which are equivalent in number to the poles of the stator 6. In addition, recessed portions 53 are formed between two of the salient pole portions 51 adjoining each other in the circumferential direction on the opposed end plate 4. These recessed portions 53 are composed of portions on the plate body 45 that are formed so as to step down in the direction separating from the curved coil end portion 81. Here, because the front face 41 and the outer circumferential surface 43 of the opposed end plate 4 face the curved coil end portion 81, the recessed portions 53 are formed on both the front face 41 and the outer circumferential surface 43 of the opposed end plate 4 so as to step down relative to the salient pole portions 51 in the direction separating from the curved coil end portion 81. Because the salient pole portions 51 and the recessed portions 53 are formed on the plate body 45 composing the opposed end plate 4 as mentioned above, the plate body 45 is structured by having a corrugated shape in which the salient portions and the recessed portions relative to the curved coil end portion 81 are alternately arranged along the circumferential direction of the opposed end plate 4.

As mentioned above, the plate body 45 has a higher magnetic permeability than that of the air because of being composed of the compacted powder material of the soft magnetic material. In addition, in general, the magnetic permeability of the permanent magnet 52 is almost the same as that of the air. Therefore, the opposed end plate 4 has a magnetic saliency because of a difference between the inductance of the salient pole portions 51 and the inductance of the permanent magnets 52 arranged in the recessed portions 53. Therefore, the opposed end plate 4 generates a reluctance torque acting in the rotating direction of the rotor 2 due to the rotating magnetic field generated by the curved coil end portion 81.

The plurality of permanent magnets 52 are arranged along the circumferential direction of the opposed end plate 4 on the surface of the opposed end plate 4 that faces the curved coil end portion 81. Here, because the front face 41 of the opposed end plate 4 mainly face the curved coil end portion 81, the permanent magnets 52 are arranged so as to face the curved coil end portion 81 at least on the front face 41 of the opposed end plate 4. In addition, in the present embodiment, the permanent magnets 52 are arranged between two of the salient pole portions 51 adjoining each other in the circumferential direction of the opposed end plate 4. Specifically, the permanent magnets 52 are mounted on the plate body 45 by being inserted in the recessed portions 53 formed between two of the salient pole portions 51 adjoining each other in the circumferential direction. In order to enable such mounting, the permanent magnet 52 is formed into the same shape as that of the space in the recessed portion 53. Consequently, the back face of the permanent magnet 52 has a stepped shape in which the radially outer portion is more projected axially toward the rotor 2 than the radially inner portion.

In the present embodiment, the permanent magnets 52 are arranged separately from each other at even intervals along the circumferential direction of the opposed end plate 4 at eight places which are equivalent in number to the poles of the stator 6. Each of the permanent magnets 52 is magnetized in the thickness direction of the opposed end plate 4 (axial direction of the rotor 2) so that the plurality of permanent magnets 52 have polarities that are alternately reversed relative to the curved coil end portion 81 along the circumferential direction of the opposed end plate 4. That is, the polarities of the plurality of permanent magnets 52 are set so that a north pole and a south pole alternate along the circumferential direction of the opposed end plate 4, when viewed from the side of the front face 41 of the opposed end plate 4. As the permanent magnets 52, various types of sintered magnets such as rare-earth magnets, ferrite magnets, or alnico magnets, bond magnets, cast magnets, or the like are preferably used.

By providing the permanent magnets 52 mentioned above, a magnet torque acting in the rotating direction of the rotor 2 can also be generated in addition to the reluctance torque by the salient pole portions 51, as the plurality of permanent magnets 52 attract or repel the rotating magnetic field generated by the curved coil end portion 81. Consequently, with the structure of this opposed end plate 4, it is possible to further increase torque of the rotating electrical machine 1, compared with the case of providing only the salient pole portions 51 as the torque generating portion 5.

In addition, in the present embodiment, the plurality of salient pole portions 51 and the plurality of permanent magnets 52 composing the torque generating portion 5 are provided in an area that faces the radial conductor portions 83 of the curved coil end portion 81 with respect to a radial direction of the opposed end plate 4. By providing the salient pole portions 51 and the permanent magnets 52 in the area mentioned above, the salient pole portions 51 and the permanent magnets 52 can efficiently receive the magnetic field that is strengthened in the area surrounded by the plurality of radial conductor portions 83 extending out from the different slots 71 and the circumferential conductor portions 84 connecting between the radial conductor portions 83. Consequently, the torque in the rotating direction of the rotor 2 can be generated by efficiently using the magnetic field from the curved coil end portion 81.

### 2. Second Embodiment

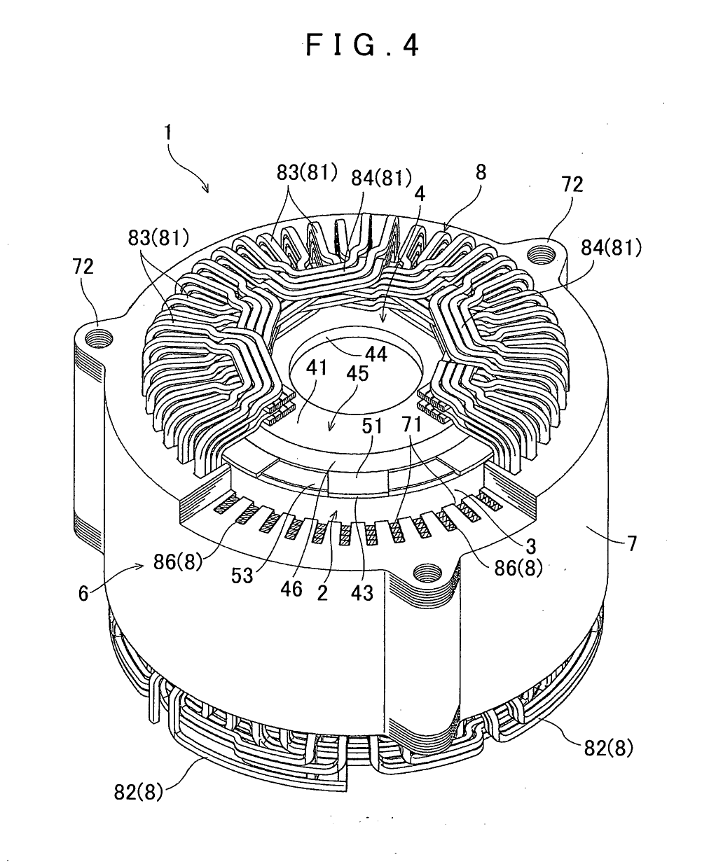

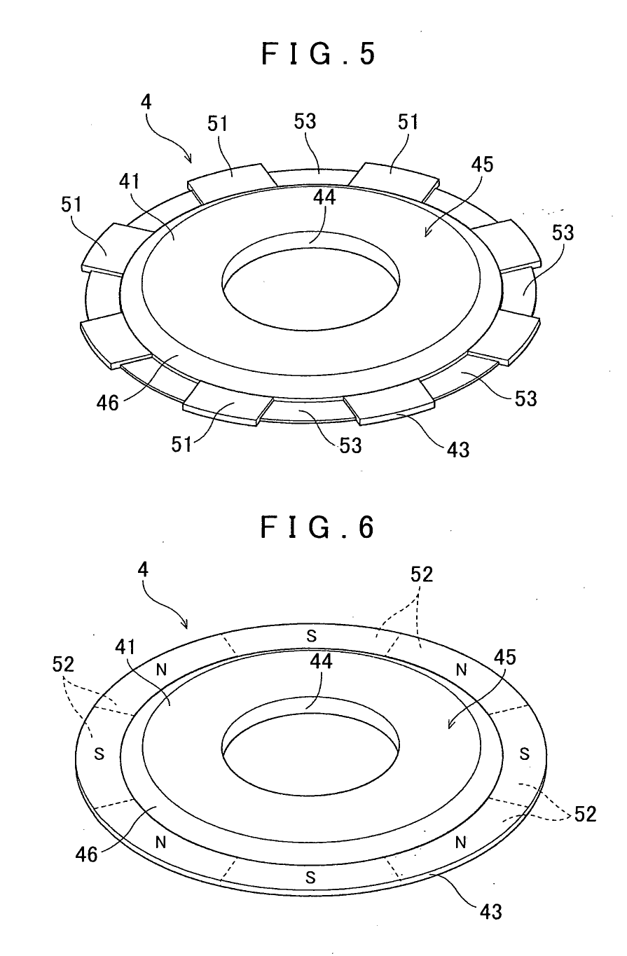

Next, a second embodiment of the present invention will be described with reference to FIGS. 4 and 5. A rotating electrical machine 1 according to the present embodiment differs from that of the first embodiment in the structure of an opposed end plate 4. That is, the opposed end plate 4 according to the present embodiment is not provided with permanent magnets 52 but provided with only salient pole portions 51 as a torque generating portion 5. That is, this opposed end plate 4 closely resembles a plate composed of only the plate body 45 in the first embodiment. In addition, this opposed end plate 4 is structured by having the plurality of salient pole portions 51 formed so as to project in directions approaching the curved coil end portion 81 along the circumferential direction of the opposed end plate 4.

In the same way as the first embodiment, the salient pole portions 51 are formed on both a front face 41 and an outer circumferential surface 43 of the opposed end plate 4 so as to project in directions approaching the curved coil end portion 81, and arranged separately from each other at even intervals along the circumferential direction of the opposed end plate 4 at eight places which are equivalent in number to the poles of the stator 6. In addition, recessed portions 53 are formed between two of the salient pole portions 51 adjoining each other in the circumferential direction on the opposed end plate 4, in the same way as the first embodiment. However, as can be understood by comparing FIG. 5 according to the present embodiment with FIG. 3 according to the first embodiment, in the present embodiment, the ratio of the circumferential length of the salient pole portion 51 to that of the recessed portion 53 differs from the ratio in the first embodiment. That is, because this opposed end plate 4 is not provided with the permanent magnets 52, and thus cannot use the magnet torque, the opposed end plate 4 has the salient pole portions 51 having a circumferential length longer than that in the first embodiment, in order to obtain a larger reluctance torque. Accordingly, the circumferential length of the recessed portion 53 is set to be shorter compared with the first embodiment. Specifically, in the opposed end plate 4 according to the present embodiment, the circumferential length of the salient pole portion 51 and the circumferential length of the recessed portion 53 are set so as to be substantially equal to each other.

The same compacted powder material as that in the first embodiment is used as compacted powder material composing the opposed end plate 4. Consequently, the opposed end plate 4 is composed of the compacted powder material of soft magnetic material, thereby having a higher magnetic permeability than that of the air. Therefore, the opposed end plate 4 has a magnetic saliency because of a difference between the inductance of the salient pole portions 51 and the inductance of the air in the recessed portions 53. Thus, the opposed end plate 4 generates the reluctance torque acting in the rotating direction of the rotor 2 due to the rotating magnetic field generated by the curved coil end portion 81. Note that elements that have not been particularly mentioned in the description of the present embodiment are structured in the same way as in the first embodiment.

### 3. Third Embodiment

Next, a third embodiment of the present invention will be described with reference to FIG. 6. A rotating electrical machine 1 according to the present embodiment differs from those of the first and the second embodiments in the structure of an opposed end plate 4. That is, the opposed end plate 4 according to the present embodiment is composed of compacted powder material formed by pressing magnetic powder particles of hard magnetic material capable of becoming permanent magnets, and a torque generating portion 5 is composed of permanent magnets 52 produced by magnetizing a part of the compacted powder material composing the opposed end plate 4. The rotating electrical machine 1 according to the present embodiment will be described below mainly regarding the differences from the first embodiment. Note that elements that will not be particularly mentioned in the description of the present embodiment are structured in the same way as in the first embodiment.

In the present embodiment, the compacted powder material composing the opposed end plate 4 is formed by pressing the magnetic powder particles of hard magnetic material capable of becoming the permanent magnets. As the magnetic powder particles mentioned above, magnetic powder composing various magnets such as raw powder of rare-earth based alloy, etc. for rare-earth magnet, raw powder of oxide ceramic, etc. for ferrite magnet, or raw powder of aluminum, nickel, cobalt, etc. for alnico magnet is preferably used. Then, the opposed end plate 4 composed of the compacted powder material is produced by sintering the magnetic powder particles mentioned above according to a manufacturing process of sintered magnets, or by heating and pressing the magnetic powder particles according to a manufacturing process of bond magnets. Here, it is the same as the first embodiment that the magnetic powder particles composing the compacted powder material are in a non-conductive state between each other, in which the current induced by the magnetic field generated by the curved coil end portion 81 is restricted. In the case of using magnetic powder particles with a high electrical conductivity in order to obtain such a non-conductive state, the compacted powder material is formed by pressing the magnetic powder particles each of which is coated with an electrically insulating film on the surface thereof, or the compacted powder material is formed by pressing the magnetic powder particles using electrically insulating material as binder. In addition, in the case of using magnetic powder particles with a very low electrical conductivity such as the raw powder for ferrite magnet, neither the electrically insulating film nor the binder of electrically insulating material is particularly required. Therefore, the compacted powder material is formed by pressing the magnetic powder particles without using other material, or by using a binder selected from various types of binder regardless of electrical insulation properties thereof.

Moreover, this opposed end plate 4 is structured by having the permanent magnets 52 produced, as the torque generating portion 5, by magnetizing a part of the compacted powder material composing the opposed end plate 4 such that it has polarities that are alternately reversed relative to the curved coil end portion 81 along the circumferential direction of the opposed end plate 4. As shown in FIG. 6, in the present embodiment, only a part in a radial direction of the compacted powder material composing the opposed end plate 4 is magnetized to produce the permanent magnets 52. Here, because a front face 41 of the opposed end plate 4 mainly faces the curved coil end portion 81, the permanent magnets 52 are magnetized so as to face the curved coil end portion 81 at least on the front face 41 of the opposed end plate 4. Specifically, the compacted powder material is magnetized in the thickness direction of the opposed end plate 4 (axial direction of the rotor 2). In addition, in the present embodiment, an area that faces the radial conductor portions 83 of the curved coil end portion 81 with respect to a radial direction of the opposed end plate 4 is magnetized to be the permanent magnets 52.

In addition, the opposed end plate 4 is divided into a plurality of sections along the circumferential direction thereof, and then magnetized so that the permanent magnets 52 have polarities that are alternately reversed relative to the curved coil end portion 81 section by section along the circumferential direction. In the present embodiment, the opposed end plate 4 is evenly divided along the circumferential direction thereof into eight sections which are equivalent in number to the poles of the stator 6, and each of the sections is magnetized in a predetermined direction. Consequently, the permanent magnets 52 are structured by being magnetized so that a north pole and a south pole alternate along the circumferential direction of the opposed end plate 4, when viewed from the side of the front face 41 of the opposed end plate 4. By providing the permanent magnets 52 as mentioned above, a magnet torque acting in the rotating direction of the rotor 2 can be generated as the plurality of permanent magnets 52 attract or repel the rotating magnetic field generated by the curved coil end portion 81.

### 4. Fourth Embodiment

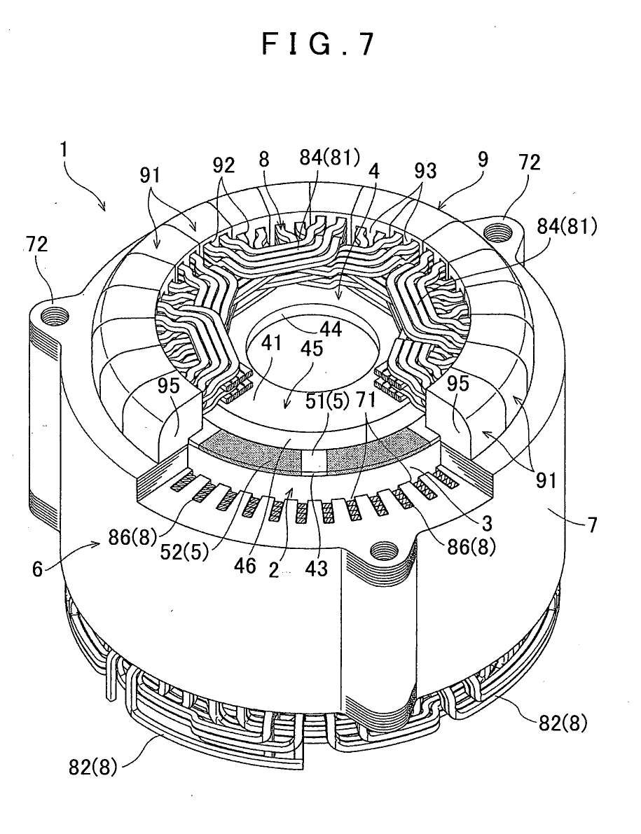

Next, a fourth embodiment of the present invention will be described with reference to FIGS. 7 to 9. A rotating electrical machine 1 according to the present embodiment differs from those of the first to the third embodiments in that a coil end core 9 is arranged by being inserted into gaps between conductors composing the curved coil end portion 81. The rotating electrical machine 1 according to the present embodiment will be described below mainly regarding the differences from the first embodiment. Note that elements that will not be particularly mentioned in the description of the present embodiment are structured in the same way as in the first embodiment.

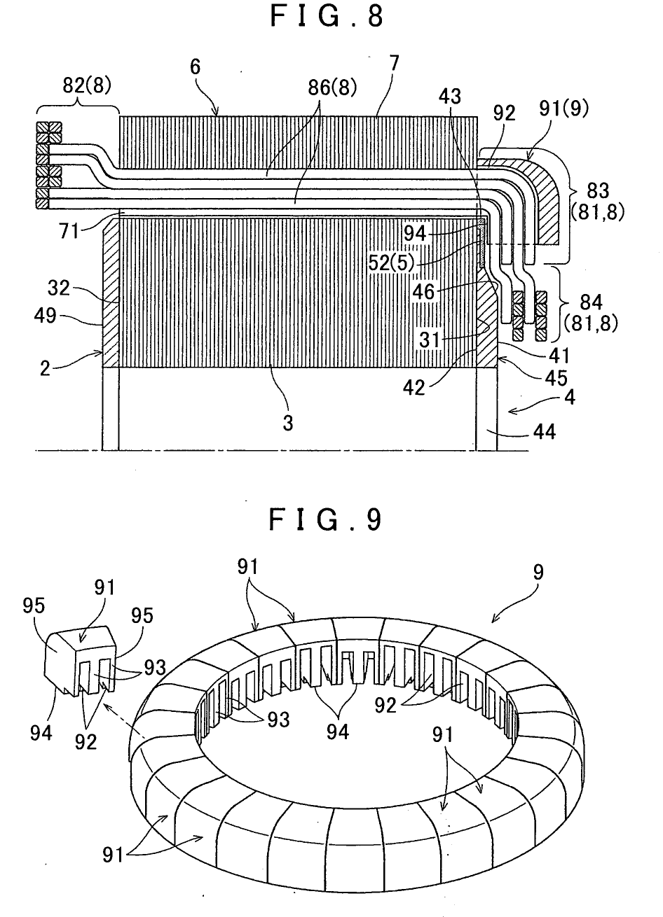

As clearly shown in FIG. 1 according to the first embodiment, a gap is provided between adjoining two of the radial conductor portions 83, in the curved coil end portion 81. Consequently, a plurality of such gaps are provided at predetermined intervals over the entire circumference. Therefore, in the present embodiment, the coil end core 9 is arranged by being inserted into these gaps between the radial conductor portions 83. As shown in FIGS. 7 and 8, the coil end core 9 has a shape covering the radial conductor portions 83 of the curved coil end portion 81. In addition, as clearly shown in FIG. 9, the coil end core 9 has a plurality of recessed grooves 92 into which the linear conductors composing the radial conductor portions 83 are inserted. These plurality of recessed grooves 92 are provided at the predetermined intervals along the circumferential direction of the coil end core 9, corresponding to the arrangement of the radial conductor portions 83 in the circumferential direction of the curved coil end portion 81. In addition, a wall body 93 is formed between adjoining two of the recessed grooves 92 so as to extend in the axial direction of the stator 6 and in a radial direction thereof in a radiating manner. Here, the coil end core 9 is provided with the same number of the recessed grooves 92 as that of the radial conductor portions 83 (that is, the same number as that of the slots 71), and also with the same number of the wall bodies 93 as that of the gaps between the radial conductor portions 83 (that is, the same number as that of teeth between the slots 71 of the stator core 7). Then, in the state in which the coil end core 9 is mounted on the stator 6 so that the linear conductors composing the radial conductor portions 83 are inserted into each of the plurality of recessed grooves 92, each of the plurality of wall bodies 93 is arranged by being inserted into the gaps between the radial conductor portions 83.

As shown in FIGS. 7 and 8, a lower surface 94 of the coil end core 9 has a stepped shape in which the radially outer portion is more projected axially toward the stator core 7 than the radially inner portion. In addition, the coil end core 9 is mounted on the stator 6 in the state in which the radially outer portion of the lower surface 94 is in contact with an axial end surface of the stator core 7. In this state, the radially inner portion of the lower surface 94 of the coil end core 9 is arranged so as to face the opposed end plate 4 of the rotor 2 at a predetermined distance.

In the present embodiment, the coil end core 9 is a split core that is split into a plurality of core pieces 91 along radial lines along radial directions of the stator 6. Then, by arranging the plurality of core pieces 91 without spaces therebetween along the circumferential direction of the curved coil end portion 81, there is formed the coil end core 9 covering the radial conductor portions 83 over the entire circumference of the curved coil end portion 81. Therefore, both sides in the circumferential direction of each of the core pieces 91 are provided with side surfaces 95 that are located on the radial lines along radial directions of the stator 6 when mounted on the stator 6. Each adjoining two of the core pieces 91 are structured such that the side surfaces 95 can make contact with each other with almost no space therebetween.

The coil end core 9 is mainly composed of compacted powder material formed by pressing magnetic powder particles which are powder particles of magnetic material. In addition, the magnetic powder particles composing the compacted powder material are in a non-conductive state between each other, in which the current induced by the magnetic field generated by the curved coil end portion 81 is restricted. In the present embodiment, the compacted powder material is formed by pressing the magnetic powder particles each of which is formed with an electrically insulating film on the surface thereof, so that the magnetic powder particles composing the compacted powder material are in the non-conductive state between each other. Here, the magnetic powder particles are powder particles of soft magnetic material, for which, powder particles of the same material as that of the opposed end plate 4 according to the first embodiment can be used. In this case, although it is preferable to constitute the coil end core 9 by a type of material used in common with the opposed end plate 4, the coil end core 9 may be constituted by a different material from that of the opposed end plate 4, among the above-mentioned types of material for the powder particles of soft magnetic material. By constituting the coil end core 9 by the compacted powder material mentioned above, the current induced by the magnetic field generated by the curved coil end portion 81 can be restricted from flowing through the coil end core 9, and thus, it is possible to suppress eddy current loss from being generated in the coil end core 9. In addition, it is possible to form a core of a complicated shape compared with the case of forming the coil end core 9 by laminating magnetic steel sheets. Consequently, the coil end core 9 can be formed into an appropriate shape in accordance with the shape of the gaps between the conductors composing the curved coil end portion 81, even if the shape of the gaps is complicated.

In the rotating electrical machine 1 according to the present embodiment, it is possible to collect the magnetic field generated by the curved coil end portion 81 at the wall bodies 93 of the coil end core 9, by providing the coil end core 9 mentioned above. Therefore, it is possible to increase the density of the magnetic flux directing toward the opposed end plate 4. Consequently, it is possible further increase torque of the rotating electrical machine 1, compared with the case of not providing the coil end core 9.

Note that FIG. 7 shows an example in which the opposed end plate 4 is arranged, as the torque generating portion 5, with the plurality of salient pole portions 51 and the plurality of permanent magnets 52 placed alternately in the circumferential direction, in the same way as the first embodiment. However, the structure of the opposed end plate 4 of the rotating electrical machine 1 provided with the coil end core 9 mentioned above is not limited to this arrangement. Therefore, in the rotating electrical machine 1 provided with the coil end core 9, it is also one of preferable embodiments of the present invention to provide the opposed end plate 4 with the same structure as that of the second or the third embodiment.

### 5. Other Embodiments

(1) In the above embodiments, description has been made using the example in which the compacted powder material is produced by the method in which the magnetic powder particles are pressed to be formed into a predetermined shape and then sintered by heating. However, embodiments of the present invention are not limited to this method, and other methods may be used to produce the compacted powder material formed by pressing the magnetic powder particles. For example, it is also one of preferable embodiments of the present invention to produce the compacted powder material by the method in which, by using various types of binders, a mixture of the magnetic powder particles and the binder is pressed and heated in a mold to be formed into a predetermined shape. In the case of using this method, it is further preferable to use electrically insulating material as the binder. As such binder, organic binder or inorganic binder can be used. As the organic binder, various types of resin can be used, such as silicon resin, epoxy resin, phenolic resin, polyester resin, polyamide resin, and polyimide resin. In addition, as the inorganic binder, for example, silicon oxide, aluminum oxide, titanium oxide, and zirconium oxide can be used. In the case of using any of these for the electrically insulating film for the magnetic powder particles, the insulating film may be structured so as to serve also as inorganic binder. In addition, in the case of using the electrically insulating material as the binder, it is possible to use the magnetic powder particles each of which is formed with an electrically insulating film on the surface thereof, but it is also possible to use magnetic powder particles not formed with such electrically insulating film. In the case of using the magnetic powder particles that are formed with no electrically insulating film and have a high electrical conductivity, it is preferable to ensure a non-conductive state between the magnetic powder particles by making the amount of the binder composed of the insulating material comparatively large. In addition, in the case of using magnetic powder particles that have a very low electrical conductivity, it is also preferable to form the compacted powder material by sintering the magnetic powder particles using neither the electrically insulating film nor the binder composed of the electrically insulating material.

(2) In the above embodiments, description has been made using the example in which only one of the coil end portions in the axial direction of the stator 6 is the curved coil end portion 81. However, embodiments of the present invention are not limited to such structure, but it is also one of preferable embodiments of the present invention to have a structure in which the coil end portions on both sides in the axial direction of the stator 6 are the curved coil end portions 81 formed to be curved inward in a radial direction of the stator core 7. In this case, it is preferable that the rotor 2 is structured to have the abovementioned opposed end plates 4 of various types such that the rotor 2 faces both of the curved coil end portions 81 on both sides in the axial direction.

(3) In the first embodiment, description has been made using the example in which, the opposed end plate 4 is structured by combining the plate body 45 composed of the compacted powder material with the magnets. In the example, the torque generating portion 5 is composed of the salient pole portions 51 formed on the plate body 45 and the permanent magnets 52 arranged between two of the salient pole portions 51 adjoining each other in the circumferential direction. However, embodiments of the present invention are not limited to this composition. Consequently, it is also one of preferable embodiments of the present invention to have a structure in which each of the permanent magnets 52 composing the torque generating portion 5 is arranged in a place other than that between adjoining two of the salient pole portions 51, for example, in a position overlapping the salient pole portion 51 in the circumferential direction. In addition, for example, in the case in which the opposed end plate 4 is structured by combining the plate body 45 composed of the compacted powder material with the magnets, it is also preferable if the torque generating portion 5 is composed of only the permanent magnets 52 mounted on the plate body 45 that is not provided with the salient pole portions 51. In this case, the plurality of permanent magnets 52 are arranged so as to be in contact with each other in the circumferential direction, or arranged so as to be separate from each other at predetermined distances in the circumferential direction.

(4) In the third embodiment, description has been made using the example in which, the compacted powder material composing the opposed end plate 4 is formed by pressing the magnetic powder particles of hard magnetic material capable of becoming permanent magnets. In the example, only a part in a radial direction of the compacted powder material composing the opposed end plate 4 is magnetized to produce the permanent magnets 52. However, embodiments of the present invention are not limited to this production method, but it is also one of preferable embodiments of the present invention to have a structure in which all of the compacted powder material composing the opposed end plate 4 is magnetized to produce the permanent magnets 52. Also in this case, the torque generating portion 5 is structured by dividing the opposed end plate 4 into a plurality of sections along the circumferential direction thereof, and then by magnetizing the opposed end plate 4 so that the permanent magnets 52 have polarities that are alternately reversed relative to the curved coil end portion 81 section by section along the circumferential direction.

(5) In the above embodiments, description has been made using the example in which the torque generating portion 5 such as the salient pole portions 51 or the permanent magnets 52 is provided in an area that faces substantially the entire radial conductor portions 83 with respect to a radial direction of the opposed end plate 4. However, embodiments of the present invention are not limited to this arrangement. Consequently, it is also one of preferable embodiments of the present invention to provide the torque generating portion 5 in an area that faces substantially the entire curved coil end portion 81 including both of the radial conductor portions 83 and the circumferential conductor portions 84 with respect to a radial direction of the opposed end plate 4. In addition, it is also one of preferable embodiments of the present invention, for example, to provide the torque generating portion 5 in an area that faces the entire radial conductor portions 83 and a part of the circumferential conductor portions 84 with respect to a radial direction of the opposed end plate 4, or to provide the torque generating portion 5 in an area that faces a part of the radial conductor portions 83 with respect to a radial direction of the opposed end plate 4.

(6) In the above embodiments, description has been made using the example in which the opposed end plate 4 is formed into a substantially circular disc shape covering the entire area of the axial one end surface 31 of the rotor core 3. However, embodiments of the present invention are not limited to this form. Consequently, it is also preferable that the opposed end plate 4 is formed, for example, into a polygonal shape such as an octagonal or a dodecagonal shape in the axial view, or into a shape, such as a star shape or a gear shape, having projections and recesses on the outer circumferential surface thereof. Note that, in either case, the opposed end plate 4 is mounted concentrically with the rotor core 3 on an axial end surface of the rotor core 3.

(7) In the above embodiments, description has been made using the example in which the opposed end plate 4 is structured to be provided with the torque generating portion 5 such as the salient pole portions 51 or the permanent magnets 52. However, embodiments of the present invention are not limited to this structure, and it is also one of preferable embodiments of the present invention to have a structure in which the opposed end plate 4 is not provided with the torque generating portion 5. In this case, the opposed end plate 4 does not generate a torque in the rotating direction of the rotor 2 by using the magnetic field generated by the curved coil end portion 81. However, because the compacted powder material composing the opposed end plate 4 has the magnetic powder particles that are in the non-conductive state between each other so that the current induced by the magnetic field generated by the curved coil end portion 81 is restricted, it is possible to cover, with the plate-shaped member of a high electrical resistance, the end portion in the axial direction of the rotor 2 that faces the curved coil end portion 81 and is most strongly influenced by the magnetic field generated by the curved coil end portion 81. Consequently, it is possible to effectively suppress the current induced by the magnetic field generated by the curved coil end portion from flowing through the rotor 2, thereby enabling to suppress the generation of eddy current loss.

(8) In the fourth embodiment, description has been made using the example in which the coil end core 9 is composed of the compacted powder material formed by pressing the magnetic powder particles which are powder particles of magnetic material. However, embodiments of the present invention are not limited to this composition. Consequently, it is also one of preferable embodiments of the present invention to compose the coil end core 9, for example, of a combination of the compacted powder material and other members such as magnetic steel sheets, or of only magnetic steel sheets.

The present invention can preferably be used for a rotating electrical machine including a stator formed by winding a coil around a stator core of a substantially cylindrical shape and a rotor rotatably supported at an inside in a radial direction of the stator.

What is claimed is:

1. A rotating electrical machine comprising:
a stator formed by winding a coil around a stator core of a substantially cylindrical shape; and
a rotor rotatably supported at an inside in a radial direction of the stator, wherein
at least one coil end portion in an axial direction of the stator is a curved coil end portion formed to be curved inward in a radial direction of the stator core,
the rotor includes a rotor core of a substantially cylindrical shape and an opposed end plate mounted concentrically with the rotor core on an axial end surface of the rotor core so as to face the curved coil end portion, and
the opposed end plate is mainly composed of compacted powder material formed by pressing magnetic powder particles which are powder particles of magnetic material, and the magnetic powder particles composing the compacted powder material are in a non-conductive state between each other, in which a current induced by the magnetic field generated by the curved coil end portion is restricted.

2. The rotating electrical machine according to claim 1, wherein the opposed end plate has a torque generating portion that generates a torque in a rotating direction of the rotor by using the magnetic field generated by the curved coil end portion, on a surface that faces the curved coil end portion.

3. The rotating electrical machine according to claim 2, wherein
the compacted powder material is formed by pressing magnetic powder particles having a higher magnetic permeability than that of the air, and
the torque generating portion is structured by having a plurality of salient pole portions formed to project in directions approaching the curved coil end portion, along a circumferential direction of the opposed end plate.

4. The rotating electrical machine according to claim 3, wherein the torque generating portion is structured by having a plurality of permanent magnets arranged between the salient pole portions adjoining each other in the circumferential direction of the opposed end plate, and the plurality of permanent magnets are arranged so as to have polarities that are alternately reversed relative to the curved coil end portion along the circumferential direction of the opposed end plate.

5. The rotating electrical machine according to claim 2, wherein the torque generating portion is structured by having a plurality of permanent magnets arranged so as to have polarities that are alternately reversed relative to the curved coil end portion along the circumferential direction of the opposed end plate.

6. The rotating electrical machine according to claim 2, wherein
the compacted powder material is formed by pressing magnetic powder particles of hard magnetic material capable of becoming permanent magnets, and
the torque generating portion is structured by having permanent magnets produced by magnetizing a part or all of the compacted powder material composing the opposed end plate so as to have polarities that are alternately reversed relative to the curved coil end portion along the circumferential direction of the opposed end plate.

7. The rotating electrical machine according to claim 2, wherein
the stator core has a plurality of slots provided at predetermined intervals along the circumferential direction thereof,
the curved coil end portion includes radial conductor portions that extend out from the slots and extend in radial directions of the stator and circumferential conductor portions that extend in the circumferential direction so as to connect between the plurality of radial conductor portions extending out from different slots, and
the torque generating portion is provided in an area that faces the radial conductor portions with respect to a radial direction of the opposed end plate.

8. The rotating electrical machine according to claim 1, wherein the compacted powder material is formed by pressing magnetic powder particles each of which is formed with an electrically insulating film on the surface thereof.

9. The rotating electrical machine according to claim 1, wherein the compacted powder material is formed by pressing magnetic powder particles using electrically insulating material as binder.

10. The rotating electrical machine according to claim 1, wherein the opposed end plate is formed into a substantially circular disc shape covering the entire axial end surface of the rotor core.

11. The rotating electrical machine according to claim 2, wherein a coil end core is arranged by being inserted into gaps between conductors composing the curved coil end portion.

12. The rotating electrical machine according to claim 11, wherein the coil end core is mainly composed of compacted powder material formed by pressing magnetic powder particles which are powder particles of magnetic material, and the magnetic powder particles composing the compacted powder material are in a non-conductive state between each other, in which a current induced by the magnetic field generated by the curved coil end portion is restricted.
